(19) United States
(12) Patent Application Publication
(10) Pub. No.: US 2024/0098377 A1
(43) Pub. Date: Mar. 21, 2024

(54) IMAGING DEVICE AND IMAGING METHOD

(71) Applicant: SONY GROUP CORPORATION, TOKYO (JP)

(72) Inventor: HIDEKI OYAIZU, TOKYO (JP)

(21) Appl. No.: 18/262,071

(22) PCT Filed: Jan. 4, 2022
(86) PCT No.: PCT/JP2022/000009

§ 371 Date: Jul. 19, 2023

(30) Foreign Application Priority Data
Jan. 28, 2021 (JP) 2021-011784

(51) Int. Cl. H04N 23/955; G03B 11/00; G03B 19/16

(52) U.S. Cl. CPC H04N 23/955; G03B 11/00; G03B 19/16

(57) ABSTRACT

The present disclosure relates to an imaging device and an imaging method capable of improving image quality of an image reconstructed by a lensless camera.

By using a mask containing a light-shielding material that shields incident light and provided with a telephoto pattern including a light-shielding region and a plurality of transmission regions that transmits the incident light in a part of the light-shielding material and is configured in the vicinity of a center and a wide-angle pattern that is an outer edge portion of the telephoto pattern and has a pitch larger than that of the telephoto pattern, the incident light is modulated and transmitted. Incident light modulated by the telephoto pattern is imaged as a telephoto imaging result, and incident light modulated by the wide-angle pattern of the mask is imaged as a wide-angle imaging result. A telephoto image is reconstructed on the basis of the telephoto imaging result, and a wide-angle image is reconstructed on the basis of the wide-angle imaging result. The present disclosure can be applied to a camera mounted on a smartphone.

### TECHNICAL FIELD

The present disclosure relates to an imaging device and an imaging method, and more particularly to an imaging device and an imaging method capable of realizing imaging from a wide angle to a telephoto angle with a thin device configuration at low cost.

### BACKGROUND ART

In recent years, smartphones and the like have been proposed in which a plurality of cameras having different focal lengths is mounted, and imaging from a wide angle to a telephoto angle can be realized (see Patent Document 1).

In normal digital cameras, a zoom lens may be mounted in order to perform imaging with different focal lengths. However, in smartphones, it is necessary to reduce a configuration of an optical system, so that a zoom lens is rarely used.

Instead, cameras having a plurality of different focal lengths are prepared, and imaging is separately performed by the cameras to realize imaging of a wide-angle image and imaging of a telephoto image in parallel.

Furthermore, in signal processing in a subsequent stage, by synthesizing the wide-angle image and the telephoto image to generate an image with an intermediate angle of view between the two images, imaging as if using a zoom lens is realized.

### CITATION LIST

### Patent Document

Patent Document 1: Japanese Patent Application Laid-Open No. 2018-170657

### SUMMARY OF THE INVENTION

### Problems to be Solved by the Invention

However, in the configuration using the plurality of cameras as in Patent Document 1, a cost increases and an occupied surface area increases.

Furthermore, in Patent Document 1, optical axes of two cameras are different, and parallax occurs between the individual cameras. Therefore, it has been necessary to correct parallax in consideration of a distance to a target before synthesizing images, when an image to be intermediate between two angles of view is synthesized.

The present disclosure has been made in view of such a situation, and is particularly to realize imaging from a wide angle to a telephoto angle with a thin device configuration and at low cost.

### Solutions to Problems

An imaging device according to one aspect of the present disclosure is an imaging device including: a mask containing a light-shielding material that shields incident light, the mask being provided with a first pattern including a light-shielding region and a plurality of transmission regions that transmits the incident light in a part of the light-shielding material and a second pattern different from the first pattern, and the mask being configured to modulate and transmit the incident light; a first sensor configured to image the incident light modulated with the first pattern of the mask, as a first imaging result including a pixel signal; a second sensor configured to image the incident light modulated with the second pattern of the mask, as a second imaging result including a pixel signal; and an image processing unit configured to reconstruct a first image on the basis of the first imaging result and reconstruct a second image on the basis of the second imaging result.

An imaging method according to one aspect of the present disclosure is an imaging method including: a step of modulating and transmitting incident light by using a mask containing a light-shielding material that shields the incident light, the mask being provided with a first pattern including a light-shielding region and a plurality of transmission regions that transmits the incident light in a part of the light-shielding material and a second pattern different from the first pattern; a step of imaging the incident light modulated with the first pattern of the mask, as a first imaging result including a pixel signal; a step of imaging the incident light modulated with the second pattern of the mask, as a second imaging result including a pixel signal; and a step of reconstructing a first image on the basis of the first imaging result and reconstructing a second image on the basis of the second imaging result.

In one aspect of the present disclosure, incident light is modulated and transmitted by a mask containing a light-shielding material that shields incident light, the mask being provided with a first pattern including a light-shielding region and a plurality of transmission regions that transmits the incident light in a part of the light-shielding material and a second pattern different from the first pattern, the incident light modulated with the first pattern of the mask is imaged as a first imaging result including a pixel signal, the incident light modulated with the second pattern of the mask is imaged as a second imaging result including a pixel signal, a first image is reconstructed on the basis of the first imaging result, and a second image is reconstructed on the basis of the second imaging result.

### BRIEF DESCRIPTION OF DRAWINGS

FIG. 1 is a diagram for explaining a configuration example of an imaging device including lenses having different focal lengths.

FIG. 2 is an external view for explaining a configuration example of an optical system of the imaging device of the present disclosure.

FIG. 3 is a side cross-sectional view for explaining a configuration example of the optical system of the imaging device of the present disclosure.

FIG. 4 is a view for explaining an imaging principle of a lensless camera.

FIG. 5 is a view for explaining a detailed configuration example of the optical system of the imaging device of the present disclosure.

FIG. 6 is a view for explaining a reason why imaging cannot be performed by two sensors arranged side by side with center positions aligned in a lens camera.

FIG. 7 is a diagram for explaining functions implemented by the imaging device of the present disclosure.

FIG. 8 is a flowchart for explaining imaging processing by the imaging device in FIG. 7.

FIG. 9 is an external view for explaining an application example of the imaging device of the present disclosure.

FIG. 10 is a side cross-sectional view for explaining an application example of the imaging device of the present disclosure.

### MODE FOR CARRYING OUT THE INVENTION

Hereinafter, a preferred embodiment of the present disclosure will be described in detail with reference to the accompanying drawings. Note that, in the present specification and the drawings, components having substantially the same functional configuration are denoted by the same reference numerals, and redundant explanations are omitted.

Hereinafter, modes for carrying out the present technology will be described. The description will be made in the following order.
1. Imaging device including lenses having different focal length
2. Imaging device of the present disclosure
3. Application example

### 1. Imaging Device Including Lenses Having Different Focal Length

The present disclosure realizes imaging from a wide angle to a telephoto angle with a thin device configuration and at low cost.

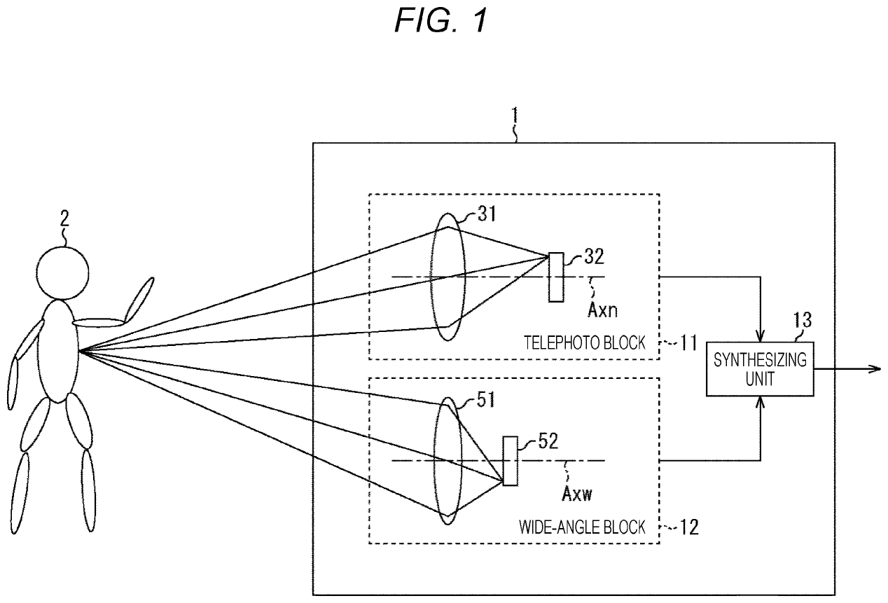

First, with reference to FIG. 1, a configuration example of an imaging device including lenses having different focal lengths will be described.

An imaging device 1 in FIG. 1 includes a telephoto block 11 that captures an image with an angle of view including a subject 2 as a telephoto image, a wide-angle block 12 that captures an image with an angle of view including the subject 2 as a wide-angle image, and a synthesizing unit 13.

The telephoto block 11 includes a telephoto lens 31 and an imaging element 32. The telephoto lens 31 condenses light in a range of a relatively narrow angle of view with a relatively long focal length, and focuses the light on an imaging surface of the imaging element 32.

The imaging element 32 captures an image of an angle of view in a relatively narrow range with a relatively long focal length as a telephoto image by imaging light condensed by the telephoto lens 31, and outputs the image to the synthesizing unit 13.

The wide-angle block 12 includes a wide-angle lens 51 and an imaging element 52. The wide-angle lens 51 condenses light in a range of a relatively wide angle of view with a relatively short focal length, and focuses light on an imaging surface of the imaging element 52.

The imaging element 52 captures an image of a relatively wide range of angle of view with a relatively short focal length as a wide-angle image by imaging light condensed by the wide-angle lens 51, and outputs the image to the synthesizing unit 13.

The synthesizing unit 13 synthesizes the telephoto image supplied from the telephoto block 11 and the wide-angle image supplied from the wide-angle block 12, to generate and output an image with an intermediate angle of view between the angle of views of the two.

However, the imaging device 1 of FIG. 1 including lenses having different focal lengths has a configuration in which imaging blocks having different optical axes are combined, and thus a surface occupied area is increased, which may cause restriction in design. Furthermore, since the lens is an essential component, it is necessary to secure a thickness of the lens in an optical axis direction and an optical distance required for focusing, which may cause restriction in design also in the thickness direction. In particular, in a smartphone or the like, thinness of the device configuration is required, but the thickness of the lens can cause restriction in design of the device configuration.

Furthermore, in the imaging device 1 of FIG. 1, since an optical axis Axn of the telephoto lens 31 is different from an optical axis Axw of the wide-angle lens 51, parallax occurs between the telephoto image captured by the telephoto block 11 and the wide-angle image captured by the wide-angle block 12.

Therefore, in order to generate an image with an intermediate angle of view between the angle of views of the two, it is necessary to correct the image in consideration of a distance to the subject 2 according to the parallax before synthesizing images, which complicates the processing.

Therefore, in the present disclosure, by coaxially configuring lensless cameras having different angle of views, imaging from a wide angle to a telephoto angle is realized with a thin device configuration and at low cost.

### 2. Imaging Device of the Present Disclosure

<Configuration Example of Optical System of Imaging Device>

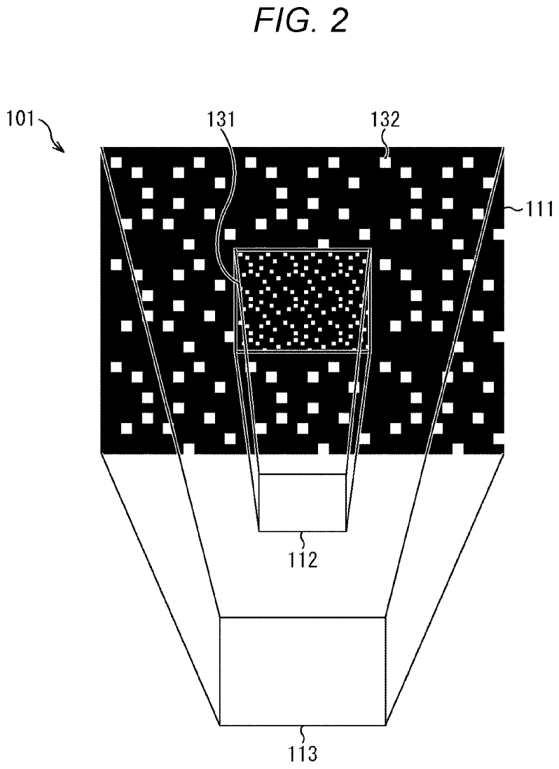

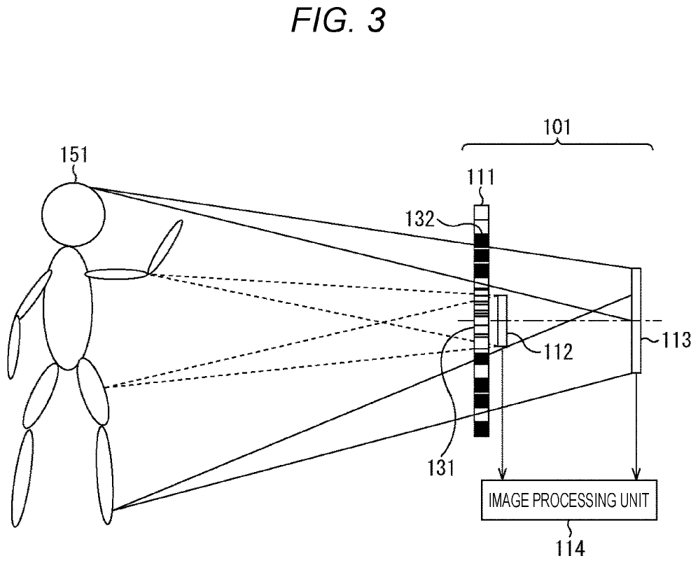

Next, with reference to FIGS. 2 and 3, a configuration example of an optical system of the imaging device of the present disclosure will be described. Note that FIG. 2 is an external view of a configuration of the optical system of the imaging device of the present disclosure, and FIG. 3 is a side cross-sectional view of the imaging device of the present disclosure.

An imaging device 101 in FIGS. 2 and 3 illustrates a configuration example of an optical system having a configuration including a mask 111, a telephoto sensor 112, a wide-angle sensor 113, and an image processing unit 114.

The imaging device 101 in FIGS. 2 and 3 is provided with the mask 111 instead of a lens, and modulates incident light with the mask 111 to generate modulated light.

Then, the imaging device 101 causes the telephoto sensor 112 and the wide-angle sensor 113 to receive modulated light generated by the mask 111 to perform imaging, and causes the image processing unit 114 to perform image processing (signal processing) on an imaging result to reconstruct an image. That is, the imaging device 101 of the present disclosure is a so-called lensless camera.

The mask 111, the telephoto sensor 112, and the wide-angle sensor 113 are arranged in a state where center positions are aligned, and the mask 111, the telephoto sensor 112, and the wide-angle sensor 113 are arranged in this order with respect to an incident direction of incident light from a subject 151.

Each of the telephoto sensor 112 and the wide-angle sensor 113 includes a complementary metal oxide semiconductor (CMOS) image sensor or a charge coupled device (CCD) image sensor, and the telephoto sensor 112 has a smaller size and also has a smaller pixel pitch than the wide-angle sensor 113.

The mask 111 is configured by a light-shielding material and includes a pattern of a light-shielding portion and an opening portion partially formed at a predetermined pitch. The mask 111 includes a telephoto pattern region 131 in which a telephoto pattern is formed and a wide-angle pattern region 132 in which a wide-angle pattern is formed, and a pitch pattern for forming the opening portion and the light-shielding portion is different between the telephoto pattern region 131 and the wide-angle pattern region 132.

Note that a pitch in each of the telephoto pattern region 131 and the wide-angle pattern region 132 corresponds to a size of the opening portion and the light-shielding portion which are to be components of the telephoto pattern region 131 and the wide-angle pattern region 132.

Near a center portion of the mask 111, the telephoto pattern region 131 is arranged in which a telephoto pattern is formed which is for modulating incident light to the telephoto sensor 112 arranged at a position closer than the wide-angle sensor 113 with respect to the mask 111.

Furthermore, in an outer edge portion of the mask 111, the wide-angle pattern region 132 is arranged in which a wide-angle pattern is formed which is for modulating incident light to the wide-angle sensor 113 arranged at a position farther than the telephoto sensor 112 with respect to the mask 111.

Incident light information obtained by the telephoto sensor 112 configured at a position close to the mask 111 needs to have an angular resolution higher than that of incident light information obtained by the wide-angle sensor 113 configured at a position farther from the mask 111 than the telephoto sensor 112. Therefore, a mask pitch formed in the telephoto pattern region 131 is set finer than a mask pitch formed in the wide-angle pattern region 132.

That is, the telephoto sensor 112 provided at a preceding stage with respect to the incident direction of the incident light receives and images only modulated light having passed through the telephoto pattern region 131 at a central portion of the mask 111, and outputs the captured image to the image processing unit 114 as a telephoto imaging result.

Whereas, the wide-angle sensor 113 provided at a subsequent stage of the telephoto sensor 112 receives and images only modulated light having passed through the wide-angle pattern region 132 of a mask outer edge portion, and outputs the captured image to the image processing unit 114 as a wide-angle imaging result.

That is, the telephoto sensor 112 is provided at a preceding stage of the wide-angle sensor 113 in a state where center positions are set at the same position. Therefore, the incident light transmitted through the telephoto pattern region 131 is blocked by the telephoto sensor 112, and thus is not incident on the wide-angle sensor 113.

With such a configuration, the telephoto sensor 112 performs telephoto imaging of the vicinity of the central portion of the entire view including the subject 151, and the wide-angle sensor 113 performs wide-angle imaging of the outer edge portion excluding the vicinity of the central portion of the entire view including the subject 151. Furthermore, the telephoto imaging by the telephoto sensor 112 and the wide-angle imaging by the wide-angle sensor 113 are performed at the same timing in a state where the individual imaging regions are independent.

The mask 111, the telephoto sensor 112, and the wide-angle sensor 113 are configured such that center positions coincide with each other. Therefore, there is no parallax between a telephoto image reconstructed on the basis of the telephoto imaging result imaged by the telephoto sensor 112 and a wide-angle image reconstructed on the basis of the wide-angle imaging result imaged by the wide-angle sensor 113.

For this reason, when the telephoto image and the wide-angle image are synthesized, parallax adjustment is unnecessary, and both images can be easily synthesized, so that an image of an intermediate angle of view of the two can be more easily generated.

Here, a pitch for forming the pattern of the opening portion and the light-shielding portion of each of the telephoto pattern region 131 and the wide-angle pattern region 132 is set to match a pixel pitch of each of the telephoto sensor 112 and the wide-angle sensor 113.

Note that a pixel pitch of the telephoto sensor 112 and the wide-angle sensor 113 corresponds to a size of a pixel that is to be a component of the telephoto sensor 112 and the wide-angle sensor 113.

Furthermore, a pitch of the pattern for forming the opening portion and the light-shielding portion of the telephoto pattern region 131 and the wide-angle pattern region 132, and an angle of view of a pair of the telephoto sensor 112 and the wide-angle sensor 113 are set by a pattern size (pitch), a sensor size, and a mask-sensor distance.

Moreover, it is desirable that the pitch of the pattern in the telephoto pattern region 131 and the wide-angle pattern region 132 used in the mask 111 has a high rank of a matrix so that matrix calculation described later can be easily solved.

That is, it is desirable that both the telephoto pattern region 131 and the wide-angle pattern region 132 used in the mask 111 satisfy a condition that autocorrelation of the pattern is high and a side lobe of a function indicating cross-correlation is low.

Examples of the pattern satisfying such a condition include, for example, a modified uniformly redundant array (MURA) pattern. For the wide-angle pattern and the telephoto pattern, a pattern that satisfies this condition and is designed according to specifications of each sensor is selected.

The configuration needs to be capable of imaging a narrower range of a target in the telephoto imaging result obtained by the telephoto sensor 112 imaging the modulated light transmitted through the telephoto pattern region 131, than that of the telephoto imaging result obtained by the wide-angle sensor 113 imaging the modulated light transmitted through the wide-angle pattern region 132.

This configuration is determined by a resolution of the sensor, a pitch of the mask pattern, and a distance between the sensor and the mask. For example, when the distance between the sensor and the mask is constant, a pitch of the pattern of the telephoto pattern region 131 and a pixel pitch of the telephoto sensor 112 are required to be narrower than a pitch of the pattern of the wide-angle pattern region 132 and a pixel pitch of the wide-angle sensor 113.

On the basis of the telephoto imaging result imaged by the telephoto sensor 112 and the wide-angle imaging result imaged by the wide-angle sensor 113, the image processing unit 114 individually reconstructs a telephoto image and a wide-angle image, and synthesizes the reconstructed telephoto image and wide-angle image to generate an image of an intermediate angle of view of these.

<Imaging Principle of Lensless Camera>

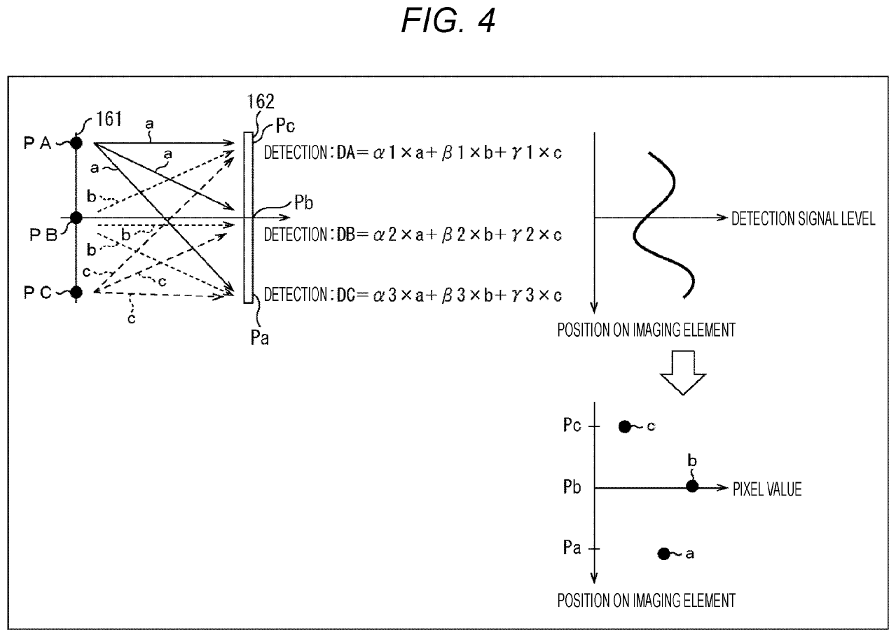

Next, with reference to FIG. 4, an imaging principle of a general lensless camera applied to the imaging device 101 will be described.

Note that, in FIG. 4, an example of a case will be described in which a mask pattern of a mask 161 applied in the lensless camera is uniform and the number of a sensor 162 as an imaging element is one.

The mask 161 is a plate-shaped configuration containing a light-shielding material and provided at a preceding stage of the sensor 162, and is formed with a transmission region provided with a hole-shaped opening portion that transmits incident light and other light-shielded non-transmission regions at a predetermined pitch, for example, as illustrated in FIG. 4. Note that a condensing element such as a lens or a Fresnel zone plate (FZP) may be provided in the opening portion.

When the mask 161 receives light from a subject surface (in reality, a surface from which radiation light from a three-dimensional subject is emitted) as incident light, the mask 161 transmits the incident light via the condensing element provided in the transmission region, thereby modulates the incident light from the subject surface as a whole to convert into modulated light, and causes the sensor 162 to receive and image the converted modulated light.

The sensor 162 captures an image formed by modulated light obtained by modulating incident light from the subject surface with the mask 161, and outputs an image including a signal in pixel units as an imaging result.

For example, as illustrated in an upper left part of FIG. 4, it is assumed that incident light from point light sources PA, PB, and PC on the subject surface is transmitted through the mask 161 and individually received as light beams of light intensities a, b, and c at positions Pa, Pb, and Pc on the sensor 162.

As illustrated in the upper left part of FIG. 4, detection sensitivity of each pixel has directivity according to an incident angle, when the incident light is modulated by the transmission region that is set in the mask 161. Providing the detection sensitivity of each pixel with the incident angle directivity here means providing light receiving sensitivity characteristics according to the incident angle of the incident light so as to be different in accordance with the region on the sensor 162.

That is, in a case of assuming that a light source constituting the subject surface is a point light source, in the sensor 162, light beams having the same light intensity and emitted from the same point light source are incident, but the incident angle changes for each region on the imaging surface of the sensor 162 by being modulated by the mask 161. Then, light receiving sensitivity characteristics, that is, the incident angle directivity is provided as the mask 161 changes the incident angle of the incident light in accordance with the region on the sensor 162. Therefore, even light beams having the same light intensity are to be detected by the mask 161 provided at a preceding stage of the imaging surface of the sensor 162 with different sensitivities in individual regions on the sensor 162, and detection signals having different detection signal levels in each region are detected.

More specifically, as illustrated in an upper right part of FIG. 4, detection signal levels DA, DB, and DC of pixels at the positions Pa, Pb, and Pc on the sensor 162 are expressed by the following Formulas (1) to (3), respectively. Note that, Formulas (1) to (3) in FIG. 4 have an inverted vertical relationship with the positions Pa, Pb, and Pc on the sensor 162 in FIG. 4.

DA=α1×a+β1×b+γ1×c (1)

DB=α2×a+β2×b+γ2×c (2)

DC=α3×a+β3×b+γ3×c (3)

Here, α1 is a coefficient for a detection signal level “a” set in accordance with an incident angle of a light beam from the point light source PA on a subject surface to be restored at the position Pa on the sensor 162.

Furthermore, β1 is a coefficient for a detection signal level “b” set in accordance with an incident angle of a light beam from the point light source PB on a subject surface to be restored at the position Pa on the sensor 162.

Moreover, γ1 is a coefficient for a detection signal level “c” set in accordance with an incident angle of a light beam from the point light source PC on a subject surface to be restored at the position Pa on the sensor 162.

Therefore, (α1×a) in the detection signal level DA indicates a detection signal level by a light beam at the position Pa from the point light source PA.

Furthermore, (β1×b) in the detection signal level DA indicates a detection signal level by a light beam at the position Pa from the point light source PB.

Moreover, (γ1×c) in the detection signal level DA indicates a detection signal level by a light beam at the position Pa from the point light source PC.

Therefore, the detection signal level DA is expressed as a composite value obtained by multiplying individual components of the point light sources PA, PB, and PC at the position Pa by the individual coefficients α1, β1, and γ1. Hereinafter, the coefficients α1, β1, and γ1 are collectively referred to as a coefficient set.

Similarly, for the detection signal level DB in the point light source Pb, a coefficient set α2, β2, and γ2 individually corresponds to the coefficient set α1, β1, and γ1 for the detection signal level DA in the point light source PA. Furthermore, for the detection signal level DC in the point light source Pc, a coefficient set α3, β3, and γ3 individually corresponds to the coefficient set α1, β1, and γ1 for the detection signal level DA in the point light source Pa.

However, detection signal levels of pixels at the positions Pa, Pb, and Pc are values expressed by a product-sum of the coefficients and the light intensities a, b, and c of light beams emitted from the point light sources PA, PB, and PC, respectively. Therefore, these detection signal levels are different from those of an image in which an image of the subject is formed, since the light intensities a, b, and c of the light beams emitted from the respective point light sources PA, PB, and PC are intermingled.

That is, by constructing a determinant (simultaneous equations) using the coefficient set α1, β1, and γ1, the coefficient set α2, β2, and γ2, and the coefficient set α3, β3, and γ3, and the detection signal levels DA, DB, and DC, and solving the light intensities a, b, and c (calculating by an inverse matrix), pixel values at the individual positions Pa, Pb, and Pc are obtained as illustrated in a lower right part of FIG. 4. As a result, a restored image (final image) that is a set of pixel values is reconstructed and restored.

Furthermore, in a case where a distance between the sensor 162 illustrated in the upper left part of FIG. 4 and the subject surface changes, the coefficient set α1, β1, and γ1, the coefficient set α2, β2, and γ2, and the coefficient set α3, β3, and γ3 individually change. However, by changing the coefficient set, restored images (final images) of the subject surface at various distances can be reconstructed.

Therefore, by changing the coefficient set to that corresponding to various distances by one time of imaging, images of the subject surface at various distances from an imaging position can be reconstructed.

As a result, in the lensless camera, it is not necessary to be aware of a phenomenon such as so-called defocus, which occurs when imaging is performed in a state where focusing is shifted in imaging by an imaging device using a lens. Further, if imaging is performed such that a subject desired to be imaged is included in a visual field, images of a subject surface at various distances can be reconstructed after imaging, by changing the coefficient set according to the distance.

Note that, since the detection signal level illustrated in the upper right part of FIG. 4 is not a detection signal level corresponding to an image in which the image of the subject is formed, the imaging result includes not a pixel value but a simple observation value. Furthermore, since the detection signal level illustrated in the lower right part of FIG. 4 is a value of each pixel of the restored image (final image) restored on the basis of a signal value for each pixel corresponding to the image in which the image of the subject is formed, the imaging result includes a pixel value. That is, the restored image (final image) of the subject surface corresponds to the captured image.

With such a configuration, since the imaging lens is not an essential component in the lensless camera, it is possible to reduce a profile of the imaging device, that is, to reduce a thickness with respect to the incident direction of light in the configuration that implements the imaging function. Furthermore, by variously changing the coefficient set, it is possible to reconstruct and restore the final image (restored image) on the subject surface at various distances.

Note that, hereinafter, an image captured by the sensor 162 before being reconstructed is simply referred to as an imaging result, and an image reconstructed and restored by signal processing of the imaging result is referred to as a final image (a restored image or a reconstructed image). Therefore, from one imaging result, images on the subject surface at various distances can be reconstructed as the final image (reconstructed image) by variously changing the coefficient set described above.

By switching and using a plurality of coefficient sets according to various distances from an imaging position to the subject surface, it is possible to reconstruct the final image (restored image) corresponding to the subject surface at various distances on the basis of the imaging result imaged by the sensor 162.

Note that, in the imaging device 101 of the present disclosure in FIGS. 2 and 3, the telephoto imaging result is imaged when the incident light modulated in the telephoto pattern region 131 in the mask 111 is received by the telephoto sensor 112, and the wide-angle imaging result is imaged when the incident light modulated by the wide-angle pattern region 132 in the mask 111 is received by the wide-angle sensor 113.

Then, a telephoto image is reconstructed as the final image by using the above-described coefficient set for the telephoto imaging result, a wide-angle image is reconstructed as the final image by using the above-described coefficient set for the wide-angle imaging result, the telephoto image and the wide-angle image synthesized, and an image with an intermediate angle of view is generated from the synthesized image.

<Detailed Configuration of Optical System of Imaging Device>

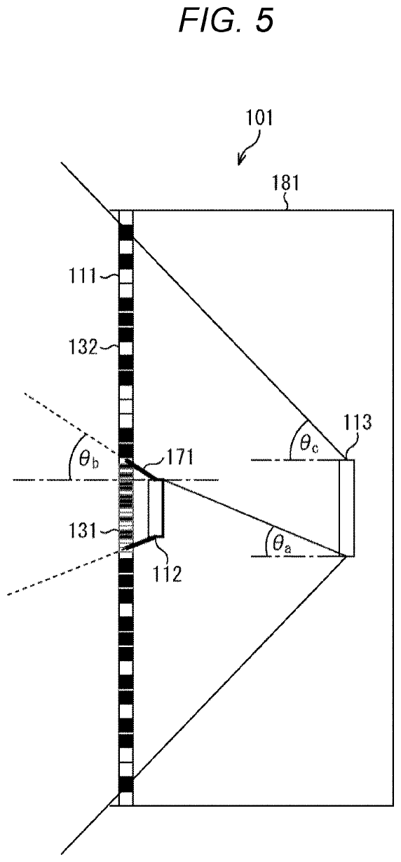

Next, with reference to FIG. 5, a detailed configuration of an optical system in the imaging device 101 will be described.

FIG. 5 illustrates a detailed configuration example of the optical system of the imaging device 101. The imaging device 101 further includes a partition wall 171 and a housing 181 in addition to the mask 111, the telephoto sensor 112, and the wide-angle sensor 113.

The housing 181 shields light so as to surround the telephoto sensor 112 and the wide-angle sensor 113, and has a configuration in which the mask 111 is fitted into an opening portion.

With such a configuration, the housing 181 shields incident light that is not transmitted through the mask 111 in incident light to the telephoto sensor 112 and the wide-angle sensor 113, and causes only incident light transmitted through the mask 111 to be incident on the telephoto sensor 112 and the wide-angle sensor 113.

The telephoto sensor 112 is provided with the partition wall 171 at a position that surrounds an edge portion of the telephoto sensor 112, in a range connecting the edge portion and an edge portion of the telephoto pattern region 131 of the mask 111. With the partition wall 171, a light receiving range of the incident light is limited such that only incident light transmitted through the telephoto pattern region 131 in the mask 111 is incident on the telephoto sensor 112, and similarly, only incident light transmitted through the wide-angle pattern region 132 is incident on the wide-angle sensor 113.

Since the telephoto sensor 112 captures a telephoto image, the image needs to have a higher resolution per angle of view than a wide-angle image captured by the wide-angle sensor 113.

Therefore, a mask pitch of the telephoto pattern region 131 and a pixel pitch of the telephoto sensor 112 are higher (finer) than a mask pitch of the wide-angle pattern region 132 and a pixel pitch of the wide-angle sensor 113.

Moreover, the wide-angle sensor 113 is designed to have a wider angle of view than the telephoto sensor 112.

Furthermore, an angle θb of the partition wall 171 with respect to a direction perpendicular to the imaging surface of the telephoto sensor 112 is smaller than an angle θc which is a maximum angle of being incident on the wide-angle sensor 113 from the mask 111 (θb<θc).

Moreover, since there is a distance between the mask 111 and the telephoto sensor 112, when observed from the wide-angle sensor 113, a part of the wide-angle pattern region 132 may be shadowed by the telephoto sensor 112 depending on a direction of the incident angle of the incident light, and the incident light may not be incident on the wide-angle sensor 113.

In that case, the final image cannot be correctly reconstructed with a matrix including the coefficient set required for the above-described calculation.

Therefore, the angle θb, which is an angle formed between the partition wall 171 and a direction perpendicular to the incident surface of the mask 111 indicated by a one-dot chain line in FIG. 5 is made larger than an angle θa formed by a straight line connecting a pixel at a lower end (an end portion on one side) in the wide-angle sensor 113 and an upper end (an end portion on another side) in the telephoto sensor 112 (θa<θb).

<Reason why Telephoto Image and Wide-Angle Image Cannot be Simultaneously Captured Even if Telephoto Sensor and Wide-Angle Sensor are Coaxially Arranged in Lens Camera>

Here, the reason why a telephoto image and a wide-angle image cannot be simultaneously captured even if the telephoto sensor and the wide-angle sensor are coaxially arranged in the lens camera will be described.

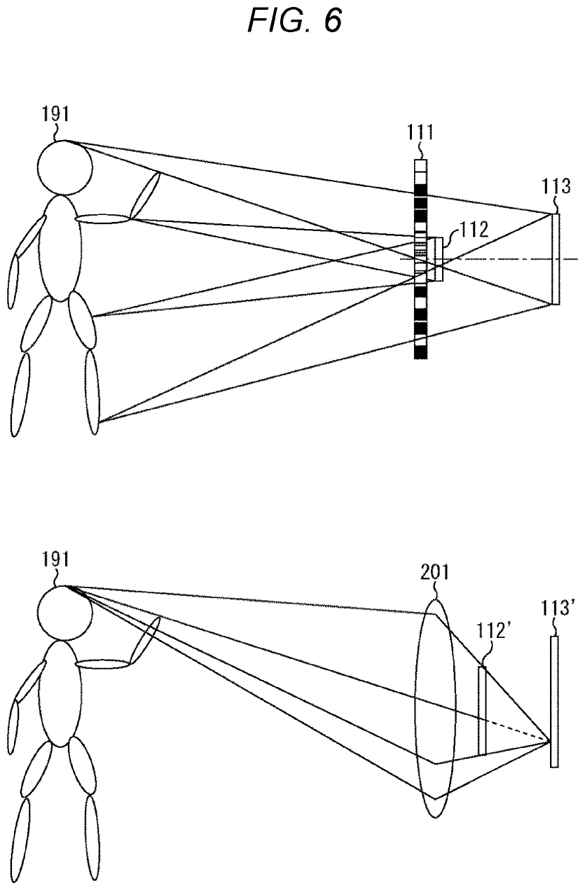

As illustrated in an upper part of FIG. 6, in the lensless camera, incident light passing through the telephoto pattern region 131 of the mask 111 in the incident light from a subject 191 is received by the telephoto sensor 112 and reconstructed as a telephoto image by image processing, and incident light passing through the wide-angle pattern region 132 is received by the wide-angle sensor 113 and then subjected to image processing to be reconstructed as a wide-angle image.

As described above, in the lensless camera, by reconstructing incident light transmitted through the telephoto pattern region 131 of the mask 111 as a telephoto image, and reconstructing incident light transmitted through the wide-angle pattern region 132 as a wide-angle image, a telephoto imaging result and a wide-angle imaging result can be simultaneously imaged.

Whereas, in the lens camera, as illustrated in a lower part of FIG. 6, light emitted from a predetermined point of the subject 191 is directed to a telephoto sensor 112′ or a wide-angle sensor 113′ by a lens 201.

Therefore, as illustrated in the lower part of FIG. 6, for example, when incident light is condensed by the lens 201 so as to be focused by the wide-angle sensor 113, a wide-angle image can be captured by the wide-angle sensor 113, but a telephoto image cannot be captured because incident light is not focused on the telephoto sensor 112.

On the contrary, although not illustrated, for example, when incident light is condensed by the lens 201 so as to be focused by the telephoto sensor 112, a telephoto image can be captured by the telephoto sensor 112, but a wide-angle image cannot be captured because incident light is not focused on the wide-angle sensor 113.

Therefore, in a case of a configuration in which the telephoto sensor 112 and the wide-angle sensor 113 are coaxially arranged in the lens camera, it is not possible to simultaneously capture a telephoto image and a wide-angle image.

As described above, in the imaging device 101 of the present disclosure functioning as a lensless camera, even if the telephoto sensor 112 and the wide-angle sensor 113 are arranged with center positions aligned, a telephoto imaging result and a wide-angle imaging result can be simultaneously acquired. Furthermore, there is no parallax between a telephoto image reconstructed using the telephoto imaging result that is the imaging result of the telephoto sensor 112 and a wide-angle image reconstructed using the wide-angle imaging result that is the imaging result of the wide-angle sensor 113, so that synthesis of the two can be facilitated.

Furthermore, since the configuration is made to function as a lensless camera, it is only necessary to provide the mask 111 including the telephoto pattern region 131 and the wide-angle pattern region 132 at a preceding stage of the telephoto sensor 112 and the wide-angle sensor 113.

Therefore, since it is not necessary to separately provide a telephoto lens and a wide-angle lens, it is possible to reduce an occupied area in a surface area, and a cost can be reduced by the configuration in which the telephoto lens and the wide-angle lens are omitted.

Furthermore, since the telephoto lens and the wide-angle lens are unnecessary, the configuration does not need to secure a thickness of the lens or a thickness according to a focal length of the lens. Therefore, the configuration of the entire device can be reduced in size and weight, and furthermore, a thin device configuration can be achieved with respect to the incident direction of the incident light (a profile can be reduced).

<Function Realized by Imaging Device>

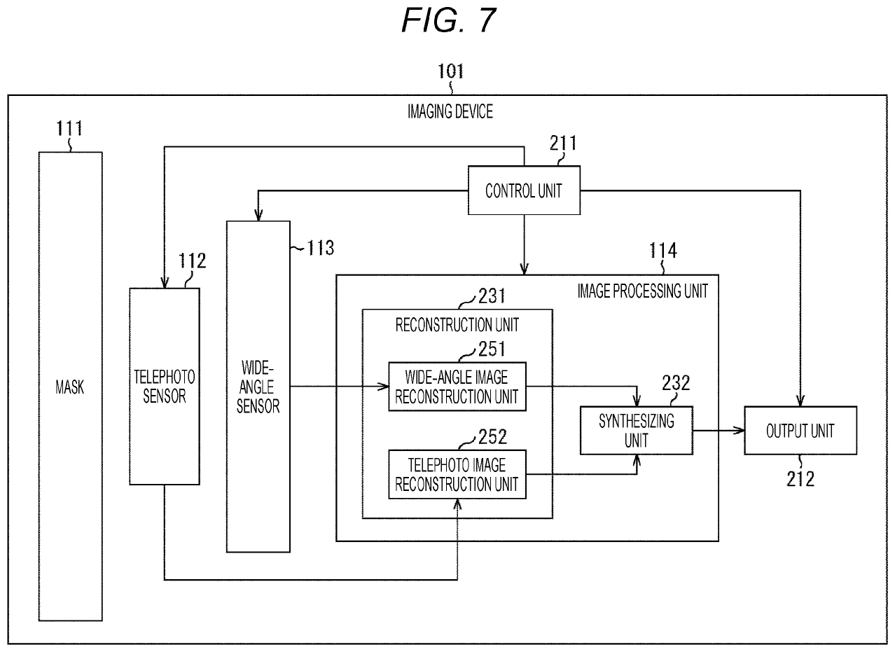

Next, with reference to a functional block diagram of FIG. 7, functions implemented by the imaging device 101 of the present disclosure will be described.

The imaging device 101 of the present disclosure includes a control unit 211 and an output unit 212 in addition to the mask 111, the telephoto sensor 112, the wide-angle sensor 113, and the image processing unit 114.

The control unit 211 includes a processor, a memory, and the like, and controls the entire operation of the imaging device 101.

The output unit 212 is a configuration to output a processing result of the image processing unit 114, and is, for example, a display device or the like such as a liquid crystal display (LCD) or an organic electro luminescence (EL) that displays an image with an intermediate angle of view, or a recording device or the like that records an image with an intermediate angle of view as data on a recording medium.

On the basis of the telephoto imaging result and the wide-angle imaging result imaged by the telephoto sensor 112 and the wide-angle sensor 113, the image processing unit 114 reconstructs and synthesizes a telephoto image and a wide-angle image, to generate an image having an intermediate angle of view, and outputs the image to the output unit 212.

More specifically, the image processing unit 114 includes a reconstruction unit 231 and a synthesizing unit 232. The reconstruction unit 231 includes a wide-angle image reconstruction unit 251 and a telephoto image reconstruction unit 252, and reconstructs a telephoto image and a wide-angle image on the basis of a telephoto imaging result and a wide-angle imaging result imaged by the telephoto sensor 112 and the wide-angle sensor 113, and outputs the telephoto image and the wide-angle image to the synthesizing unit 232.

The wide-angle image reconstruction unit 251 reconstructs the wide-angle image by performing matrix calculation using the coefficient set described above on the wide-angle imaging result imaged by the wide-angle sensor 113, and outputs the wide-angle image to the synthesizing unit 232.

The telephoto image reconstruction unit 252 reconstructs the telephoto image by performing matrix calculation using the coefficient set described above on the telephoto imaging result imaged by the telephoto sensor 112, and outputs the telephoto image to the synthesizing unit 232.

The synthesizing unit 232 synthesizes the reconstructed telephoto image and wide-angle image to generate an image with an intermediate angle of view from the image as a synthesis result, and outputs the image to the output unit 212 to display or record the image.

<Imaging Processing by Imaging Device of Present Disclosure>

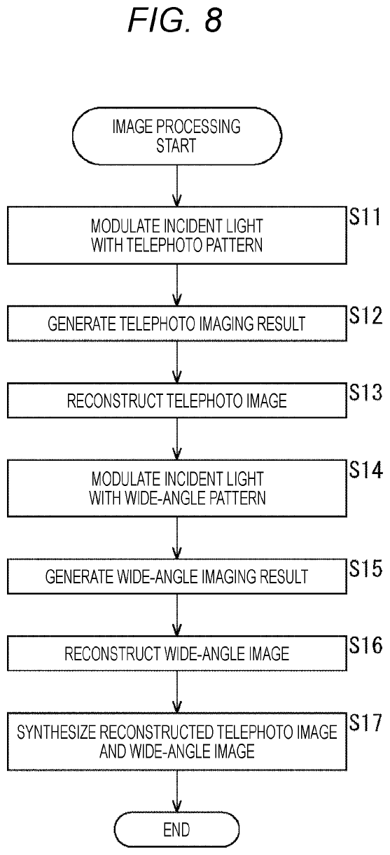

Next, with reference to a flowchart of FIG. 8, imaging processing by the imaging device 101 of the present disclosure will be described.

In step S11, by the telephoto pattern region 131 in the mask 111, incident light is modulated and made incident on the telephoto sensor 112.

In step S12, the telephoto sensor 112 captures an image formed by light modulated by the telephoto pattern region 131 of the mask 111, and outputs the image to the image processing unit 114 as a telephoto imaging result.

In step S13, on the basis of the telephoto imaging result obtained by capturing the image formed by the modulated light output from the telephoto sensor 112, the telephoto image reconstruction unit 252 of the image processing unit 114 reconstructs a telephoto image as the final image by matrix calculation using a predetermined coefficient set corresponding to a distance from an imaging position of the imaging device 101 to a subject surface, and outputs the telephoto image to the synthesizing unit 232.

That is, a determinant (simultaneous equations) using the coefficient set described with reference to Formulas (1) to (3) described above is configured and calculated for the telephoto imaging result, thereby the final image (restored image) of the telephoto image is obtained.

In step S14, by the wide-angle pattern region 132 in the mask 111, incident light is modulated and made incident on the wide-angle sensor 113.

In step S15, the wide-angle sensor 113 captures an image formed by light modulated by the wide-angle pattern region 132 of the mask 111, and outputs the image to the image processing unit 114 as a wide-angle imaging result.

In step S16, on the basis of the wide-angle imaging result obtained by capturing the image formed by the modulated light output from the wide-angle sensor 113, the wide-angle image reconstruction unit 251 of the image processing unit 114 reconstructs a wide-angle image as the final image by matrix calculation using a predetermined coefficient set corresponding to a distance from an imaging position of the imaging device 101 to a subject surface, and outputs the wide-angle image to the synthesizing unit 232.

That is, a determinant (simultaneous equations) using the coefficient set described with reference to Formulas (1) to (3) described above is configured and calculated for the telephoto imaging result, thereby the final image (restored image) of the telephoto image is obtained.

In step S17, the synthesizing unit 232 synthesizes the wide-angle image supplied from the wide-angle image reconstruction unit 251 of the reconstruction unit 231 and the telephoto image supplied from the telephoto image reconstruction unit 252, to generate an image having a predetermined intermediate angle of view between the wide-angle image and the telephoto image, and outputs the image to the output unit 212.

With the above processing, by the imaging device 101 of the present disclosure, by reconstructing the telephoto image and the wide-angle image as images having no parallax on the basis of the wide-angle imaging result imaged by the wide-angle sensor 113 and the telephoto imaging result imaged by the telephoto sensor 112 in a state where the wide-angle sensor 113 and the telephoto sensor 112 are adjusted to have center positions coincide with each other, the telephoto image and the wide-angle image can be easily synthesized, and an image with an intermediate angle of view can be easily generated.

### 3. Application Example

In the above, an example has been described in which the telephoto image and the wide-angle image to be reconstructed are easily synthesized, by configuring the mask 111 including the telephoto pattern region 131 and the wide-angle pattern region 132, the telephoto sensor 112, and the wide-angle sensor 113 in a state where center positions are aligned.

However, the number of sensors may be set to three or more, and the mask 111 may be provided with different patterns according to the number of sensors.

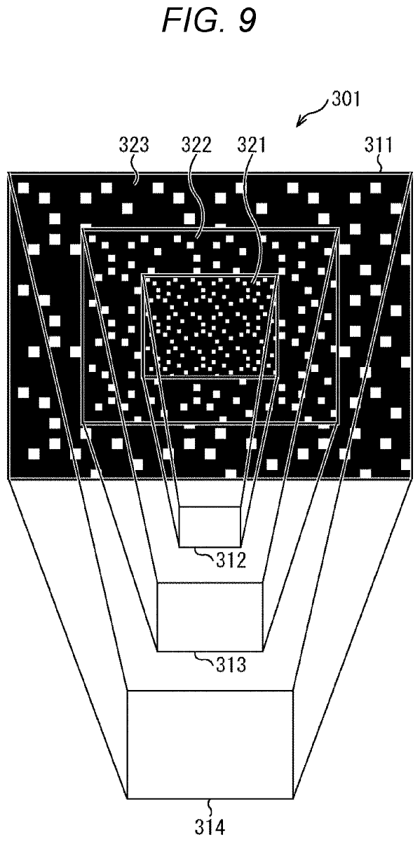

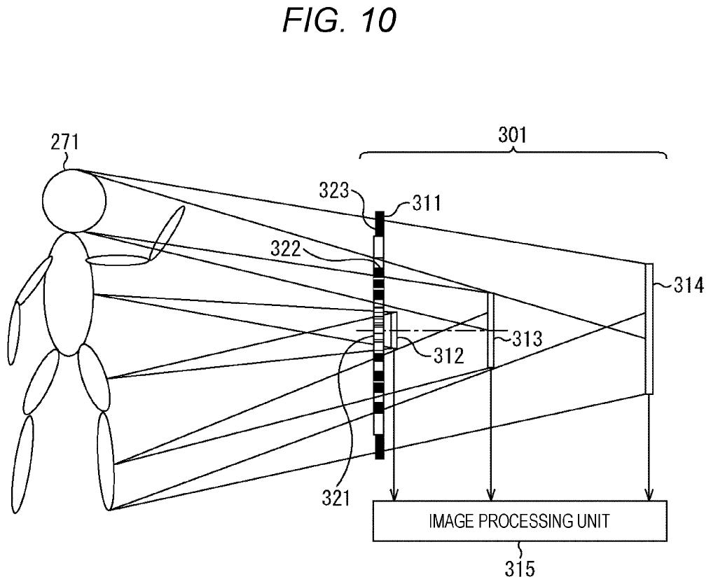

FIGS. 9 and 10 illustrate a configuration example of an imaging device 301 including three sensors and masks having different patterns according to the number of sensors.

That is, the imaging device 301 in FIGS. 9 and 10 includes a mask 311, a telephoto sensor 312, a wide-angle sensor 313, an ultra-wide-angle sensor 314, and an image processing unit 315.

Also in the imaging device 301, the mask 311, the telephoto sensor 312, the wide-angle sensor 313, and the ultra-wide-angle sensor 314 are arranged in the order of the mask 311, the telephoto sensor 312, the wide-angle sensor 313, and the ultra-wide-angle sensor 314 from an incident direction of incident light in a state where individual center positions are aligned.

Furthermore, in the mask 311, a telephoto pattern region 321 formed with a telephoto pattern is arranged in the vicinity of a center, a wide-angle pattern region 322 formed with a wide-angle pattern is arranged around the telephoto pattern region 321, and an ultra-wide-angle pattern region 323 formed with an ultra wide-angle pattern is arranged in an outer edge portion around the wide-angle pattern region 322.

With such a configuration, the telephoto sensor 312 images modulated light that has been modulated by being transmitted through the telephoto pattern region 321 in the mask 311, and outputs the image to the image processing unit 315 as a telephoto imaging result.

Furthermore, the wide-angle sensor 313 images modulated light that has been modulated by being transmitted through the wide-angle pattern region 322 in the mask 311, and outputs the image to the image processing unit 315 as a wide-angle imaging result.

Moreover, the ultra-wide-angle sensor 314 images modulated light that has been modulated by being transmitted through the ultra-wide-angle pattern region 323 in the mask 311, and outputs the image to the image processing unit 315 as an ultra-wide-angle imaging result.

Then, on the basis of the telephoto imaging result, the wide-angle imaging result, and the ultra-wide-angle imaging result, the image processing unit 315 reconstructs a telephoto image, a wide-angle image, and an ultra-wide-angle image in which center positions are aligned by matrix calculation using a coefficient set, and synthesizes these images to generate and output an image having any intermediate angle of view from the telephoto image to the ultra-wide-angle image.

By arranging the mask 311, the telephoto sensor 312, the wide-angle sensor 313, and the ultra-wide-angle sensor 314 with the individual center positions aligned by the configuration like the imaging device 301, there is no parallax in the telephoto image, the wide-angle image, and the ultra-wide-angle image to be reconstructed, so that synthesis of these can be facilitated.

Furthermore, since the configuration functions as a lensless camera, it is only necessary to provide the mask 311 in which the telephoto pattern region 321, the wide-angle pattern region 322, and the ultra-wide-angle pattern region 323 are arranged sequentially from the vicinity of the center, at a preceding stage of the telephoto sensor 312, the wide-angle sensor 313, and the ultra-wide-angle sensor 314.

For this reason, since it is not necessary to individually provide a telephoto lens, a wide-angle lens, and an ultra-wide-angle lens, a surface occupied area can be reduced, and cost reduction can be achieved.

Furthermore, since the telephoto lens, the wide-angle lens, and the ultra-wide-angle lens are unnecessary, the configuration does not need to secure a thickness according to a thickness of the lens or a focal length of the lens. Therefore, the configuration of the entire device can be reduced in size and weight, and further, can be reduced in thickness (reduced in profile) with respect to an incident direction of incident light.

Moreover, the number of sensors according to angles of view may be three or more. In this case, the mask requires a plurality of regions in which a pattern of a pitch according to the angle of view of each sensor is formed in accordance with the number of sensors.

Note that the present disclosure can also have the following configurations.
<1> An imaging device including:
a mask containing a light-shielding material that shields incident light, the mask being provided with a first pattern including a light-shielding region and a plurality of transmission regions that transmits the incident light in a part of the light-shielding material and a second pattern different from the first pattern, and the mask being configured to modulate and transmit the incident light;
a first sensor configured to image the incident light modulated with the first pattern of the mask, as a first imaging result including a pixel signal;
a second sensor configured to image the incident light modulated with the second pattern of the mask, as a second imaging result including a pixel signal; and
an image processing unit configured to reconstruct a first image on the basis of the first imaging result and reconstruct a second image on the basis of the second imaging result.
<2> The imaging device according to <1>, in which
the second pattern in the mask is provided at an outer edge portion of the first pattern.
<3> The imaging device according to <1>, in which
the mask, the first sensor, and the second sensor are arranged with individual center positions aligned on a straight line in order of the mask, the first sensor, and the second sensor, with respect to an incident direction of the incident light.
<4> The imaging device according to <1>, in which
a component constituting the first pattern is larger than a component constituting the second pattern.
<5> The imaging device according to <1>, in which
a component constituting the first pattern and a component constituting the second pattern are the plurality of transmission regions and the light-shielding region.
<6> The imaging device according to <1>, in which
a maximum incident angle of the incident light on the first sensor is smaller than a maximum incident angle of the incident light on the second sensor.
<7> The imaging device according to <1>, in which
a partition wall is formed in a range connecting an edge portion of the first sensor and an edge portion of the first pattern in the mask.
<8> The imaging device according to <7>, in which
an angle formed by the partition wall with respect to a direction perpendicular to the mask is larger than an angle formed by a straight line connecting an end portion on one side in the first sensor and an end portion on another side in the second sensor with respect to a direction perpendicular to the mask.
<9> The imaging device according to <1>, further including
a synthesizing unit configured to synthesize the first image with the second image and synthesize an angle of view of the first image with an angle of view of the second image.
<10> The imaging device according to <9>, in which
the synthesizing unit generates an intermediate angle of view from an angle of view of the first image to an angle of view of the second image, from an image in which the first image and the second image are synthesized.
<11> The imaging device according to any one of <1> to <10>, in which
the first pattern and the second pattern are a modified uniformly redundant array (MURA).
<12> The imaging device according to <1>, in which
a pixel pitch of the first sensor is smaller than a pixel pitch of the second sensor.
<13> An imaging method including:
a step of modulating and transmitting incident light by using a mask containing a light-shielding material that shields the incident light, the mask being provided with a first pattern including a light-shielding region and a plurality of transmission regions that transmits the incident light in a part of the light-shielding material and a second pattern different from the first pattern;
a step of imaging the incident light modulated with the first pattern of the mask, as a first imaging result including a pixel signal;
a step of imaging the incident light modulated with the second pattern of the mask, as a second imaging result including a pixel signal; and
a step of reconstructing a first image on the basis of the first imaging result and reconstructing a second image on the basis of the second imaging result.

### REFERENCE SIGNS LIST

101 Imaging device
111 Mask
112 Telephoto sensor
113 Wide-angle sensor
114 Image processing unit
131 Telephoto pattern region
132 Wide-angle pattern region
151 Subject
171 Partition wall
181 Housing
191 Subject
301 Imaging device
311 Mask
312 Telephoto sensor
313 Wide-angle sensor
314 Ultra-wide-angle sensor
315 Image processing unit
321 Telephoto pattern region
322 Wide-angle pattern region
323 Ultra-wide-angle pattern region

1. An imaging device comprising:
a mask containing a light-shielding material that shields incident light, the mask being provided with a first pattern including a light-shielding region and a plurality of transmission regions that transmits the incident light in a part of the light-shielding material and a second pattern different from the first pattern, and the mask being configured to modulate and transmit the incident light;
a first sensor configured to image the incident light modulated with the first pattern of the mask, as a first imaging result including a pixel signal;
a second sensor configured to image the incident light modulated with the second pattern of the mask, as a second imaging result including a pixel signal; and
an image processing unit configured to reconstruct a first image on a basis of the first imaging result and reconstruct a second image on a basis of the second imaging result.

2. The imaging device according to claim 1, wherein
the second pattern in the mask is provided at an outer edge portion of the first pattern.

3. The imaging device according to claim 1, wherein
the mask, the first sensor, and the second sensor are arranged with individual center positions aligned on a straight line in order of the mask, the first sensor, and the second sensor, with respect to an incident direction of the incident light.

4. The imaging device according to claim 1, wherein
a component constituting the first pattern is larger than a component constituting the second pattern.

5. The imaging device according to claim 1, wherein
a component constituting the first pattern and a component constituting the second pattern are the plurality of transmission regions and the light-shielding region.

6. The imaging device according to claim 1, wherein
a maximum incident angle of the incident light on the first sensor is smaller than a maximum incident angle of the incident light on the second sensor.

7. The imaging device according to claim 1, wherein
a partition wall is formed in a range connecting an edge portion of the first sensor and an edge portion of the first pattern in the mask.

8. The imaging device according to claim 7, wherein
an angle formed by the partition wall with respect to a direction perpendicular to the mask is larger than an angle formed by a straight line connecting an end portion on one side in the first sensor and an end portion on another side in the second sensor with respect to a direction perpendicular to the mask.

9. The imaging device according to claim 1, further comprising
a synthesizing unit configured to synthesize the first image with the second image and synthesize an angle of view of the first image with an angle of view of the second image.

10. The imaging device according to claim 9, wherein
the synthesizing unit generates an intermediate angle of view from an angle of view of the first image to an angle of view of the second image, from an image in which the first image and the second image are synthesized.

11. The imaging device according to claim 1, wherein
the first pattern and the second pattern are a modified uniformly redundant array (MURA).

12. The imaging device according to claim 1, wherein
a pixel pitch of the first sensor is smaller than a pixel pitch of the second sensor.

13. An imaging method comprising:
a step of modulating and transmitting incident light by using a mask containing a light-shielding material that shields the incident light, the mask being provided with a first pattern including a light-shielding region and a plurality of transmission regions that transmits the incident light in a part of the light-shielding material and a second pattern different from the first pattern;
a step of imaging the incident light modulated with the first pattern of the mask, as a first imaging result including a pixel signal;
a step of imaging the incident light modulated with the second pattern of the mask, as a second imaging result including a pixel signal; and
a step of reconstructing a first image on a basis of the first imaging result and reconstructing a second image on a basis of the second imaging result.
